(19) United States
(12) Patent Application Publication
(10) Pub. No.: US 2026/0112019 A1
(43) Pub. Date: Apr. 23, 2026

(54) BATTERY INSPECTION APPARATUS AND BATTERY INSPECTION METHOD

(71) Applicant: SK On Co., Ltd., Seoul (KR)

(72) Inventors: Jung Soo CHANG, Daejeon (KR); Kyeung Su SHIN, Daejeon (KR); Eun Taek OH, Daejeon (KR); Jeong Ho JO, Daejeon (KR); Dong Gyun KIM, Daejeon (KR); Ha Ran WON, Daejeon (KR); Tae Kyu LEE, Daejeon (KR)

(21) Appl. No.: 19/363,647

(22) Filed: Oct. 21, 2025

(30) Foreign Application Priority Data
Oct. 21, 2024 (KR) 10-2024-0144062
Jan. 16, 2025 (KR) 10-2025-0006744

(51) Int. Cl. G06T 7/00; G06T 7/11

(52) U.S. Cl. CPC G06T 7/0006; G06T 7/11; G06T 2207/10016; G06T 2207/10024; G06T 2207/10048

(57) ABSTRACT

The battery inspection apparatus comprises: a transfer unit configured to support and move an electrode sheet including an insulating coating portion formed at a boundary between an electrode active material layer and a non-coated portion; an image acquisition unit configured to record the insulating coating portion and including a first illumination for irradiating light of a predetermined wavelength band to the electrode sheet and a second illumination for irradiating white light; and a controller configured to acquire an image obtained from the image acquisition unit, derive a width of an insulating coating overlap portion in which the insulating coating portion and the electrode active material layer are overlapped, and detect a surface defect.

### CROSS-REFERENCE TO RELATED PATENT APPLICATION

The present application claims priority under 35 U.S. C. § 119(a) to Korean patent application number 10-2024-0144062 filed on Oct. 21, 2024, and 10-2025-0006744 filed on Jan. 16, 2025 in the Korean Intellectual Property Office, the entire disclosure of which is incorporated by reference herein.

### BACKGROUND OF THE INVENTION

### 1. Field

Embodiments of the present disclosure relate to a battery inspection apparatus and a battery inspection method. More specifically, the present disclosure relates to a battery inspection apparatus and a battery inspection method for inspecting a part of a battery.

### 2. Description of the Related Art

In a battery manufacturing process, an electrode sheet in which an active material layer is coated on a current collector may be manufactured. In the manufactured electrode sheet, a defect may occur in an insulating coating portion disposed at a boundary between an active material layer of the electrode and a non-coated portion. In order to secure stability of the battery and improve manufacturing efficiency, a technology for quickly and accurately inspecting a defect of the insulating coating portion without material loss is required.

### SUMMARY OF THE INVENTION

First, according to one aspect of the present disclosure, the problem to be solved is to improve stability of a battery.

Second, according to another aspect of the present disclosure, the problem to be solved is to improve manufacturing efficiency of a battery.

Third, according to still another aspect of the present disclosure, the problem to be solved is to improve inspection efficiency of a battery.

Meanwhile, the present disclosure can be widely applied to green technology fields such as Electric Vehicles, Battery Charging Stations, Energy Storage Systems (ESS), and other battery-utilizing technologies including Photovoltaics and Wind Power. In addition, the present disclosure can be used for eco-friendly mobility including Electric Vehicles and Hybrid Vehicles to suppress air pollution and greenhouse gas emissions and to prevent climate change.

As a technical means to achieve the technical objects, a battery inspection apparatus according to the present disclosure may comprise: a transfer unit configured to support and move an electrode sheet including an insulating coating portion formed at a boundary between an electrode active material layer and a non-coated portion; an image acquisition unit configured to record a video of the insulating coating portion and including a first illumination for irradiating light of a predetermined wavelength band to the electrode sheet and a second illumination for irradiating white light; and a controller configured to acquire an image obtained from the image acquisition unit, derive a width of an insulating coating overlap portion in which the insulating coating portion and the electrode active material layer are overlapped, and detect a surface defect.

In addition, the image acquisition unit may further comprise one camera configured to record the insulating coating portion at an angle range of greater than about 45 degrees and less than about 65 degrees with respect to the insulating coating portion.

In addition, a resolution of the camera may be about 25 micrometers or less.

In addition, the first illumination may form an angle range of greater than about 75 degrees and less than about 95 degrees with respect to the insulating coating portion.

In addition, a wavelength range of the predetermined wavelength band of the first illumination may be greater than about 350 nm and less than about 495 nm.

In addition, a distance between the first illumination and the insulating coating portion may be between 90 mm and 110 mm.

In addition, the second illumination may form an angle range of greater than about 85 degrees and less than about 105 degrees with respect to the insulating coating portion.

In addition, a wavelength range of the second illumination may be greater than about 380 nm and less than about 760 nm.

In addition, a distance between the second illumination and the insulating coating portion may be between about 90 mm and about 110 mm.

In addition, an image obtained from the image acquisition unit may include a video recorded under the first illumination and a video recorded under the second illumination.

In addition, the controller may set a region of interest in a part of a video recorded under the first illumination.

In addition, the controller may set sub-regions of interest obtained by subdividing the region of interest.

In addition, the controller may extract a boundary of the insulating coating overlap portion for each sub-region of interest based on image information of each of the sub-regions of interest.

In addition, the controller may derive a width of the insulating coating overlap portion based on the extracted boundary of the insulating coating overlap portion.

In addition, the controller may detect a surface defect of the insulating coating overlap portion based on a video recorded under the second illumination.

In addition, the controller may determine whether the insulating coating portion is defective based on the width of the insulating coating overlap portion and whether a surface defect is present.

As a technical means to achieve the technical objects, a battery inspection method according to the present disclosure may comprise: irradiating a first illumination that irradiates light of a predetermined wavelength band and a second illumination that irradiates white light while transferring, by a transfer unit, an electrode sheet including an insulating coating portion formed at a boundary between an electrode active material layer and a non-coated portion, and recording a video through an image acquisition unit; and acquiring a video recorded through the image acquisition unit, and deriving a width of an insulating coating overlap portion in which the insulating coating portion and the electrode active material layer are overlapped and detecting a surface defect through a controller.

In addition, the deriving of the width of the insulating coating overlap portion and detecting of the surface defect may comprise: deriving the width of the insulating coating overlap portion based on a video recorded by irradiating the first illumination; and detecting a surface defect of the insulating coating overlap portion based on a video recorded by irradiating the second illumination.

In addition, the deriving of the width of the insulating coating overlap portion may comprise: setting a region of interest in a part of a video recorded by irradiating the first illumination; subdividing the region of interest to set sub-regions of interest; extracting a boundary of the insulating coating overlap portion for each sub-region of interest based on image information of each of the sub-regions of interest; and deriving the width of the insulating coating overlap portion based on the extracted boundary of the insulating coating overlap portion.

In addition, the method may further comprise determining whether the insulating coating portion is defective based on the width of the insulating coating overlap portion and whether a surface defect is present.

First, according to one embodiment of the present disclosure, stability of a battery can be improved.

Second, according to another embodiment of the present disclosure, manufacturing efficiency of a battery can be improved.

Third, according to still another embodiment of the present disclosure, inspection efficiency of a battery can be improved.

### BRIEF DESCRIPTION OF THE DRAWINGS

FIG. 1 is an example of a battery inspection apparatus according to the present disclosure.

FIG. 2 is a block diagram of a battery inspection apparatus according to the present disclosure.

FIG. 3 is an example of an electrode sheet to be inspected by the battery inspection apparatus according to the present disclosure.

FIG. 4 is a flowchart illustrating an example of a battery inspection method according to the present disclosure.

FIG. 5 is a flowchart specifically illustrating step S20 of FIG. 4.

FIG. 6 is a plan view showing an enlarged view of region A of FIG. 3.

FIG. 7 is a plan view showing sub-regions of interest set in region A of FIG. 6.

### DETAILED DESCRIPTION

Hereinafter, preferred embodiments of the present disclosure will be described in detail with reference to the accompanying drawings. The configuration of the apparatus or the control method described below is merely for illustrating embodiments of the present disclosure and is not intended to limit the scope of the present disclosure, and reference numerals used consistently throughout the specification denote the same elements.

The use of terms with expressions such as “first,” “second,” or “third” preceding components is merely for preventing confusion between the referenced components, and is irrelevant to order, importance, or a master-slave relationship among the components. For example, an invention including only a second component without a first component may also be implemented.

Singular expressions used in the present disclosure may include plural expressions unless clearly indicated otherwise by the context.

Meanwhile, in the present disclosure, the terms battery, secondary battery, or cell are used to mean the same as battery cell.

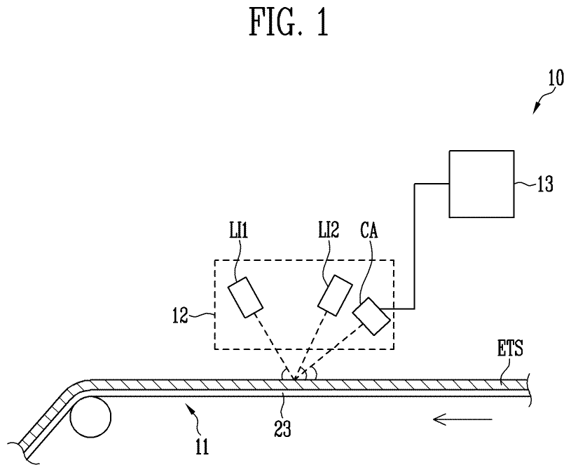

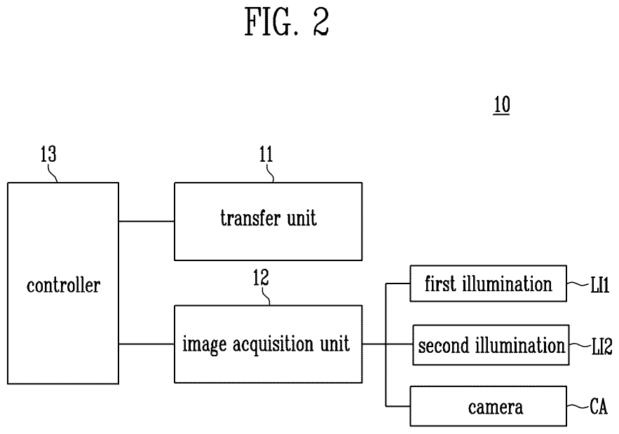

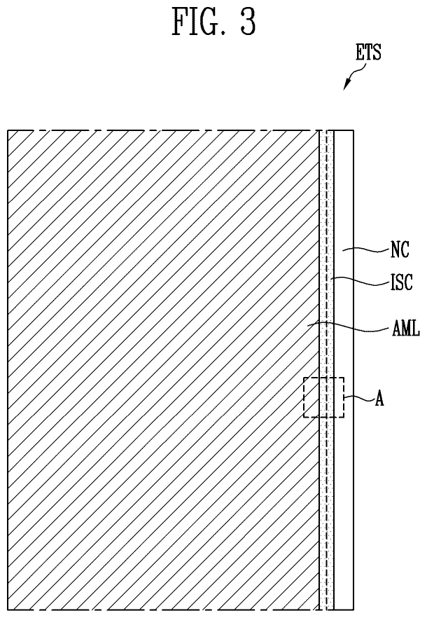

FIG. 1 is an example of a battery inspection apparatus according to the present disclosure. FIG. 2 is a block diagram of a battery inspection apparatus according to the present disclosure. FIG. 3 is an example of an electrode sheet to be inspected by the battery inspection apparatus according to the present disclosure.

Referring to FIGS. 1 and 2, a battery inspection apparatus 10 according to the present disclosure is a battery inspection apparatus for inspecting whether an electrode sheet ETS is defective, and may include a transfer unit 11, an image acquisition unit 12, and a controller 13.

The transfer unit 11 may support and move the electrode sheet ETS. That is, the transfer unit 11 may be disposed below the electrode sheet ETS to support and carry the electrode sheet ETS, and may include a stage that carries the electrode sheet ETS and a transfer portion that transfers the electrode sheet ETS onto the stage. The electrode sheet ETS may be placed on the stage in a state in which a surface on which an electrode active material layer AML of FIG. 3 is formed faces upward.

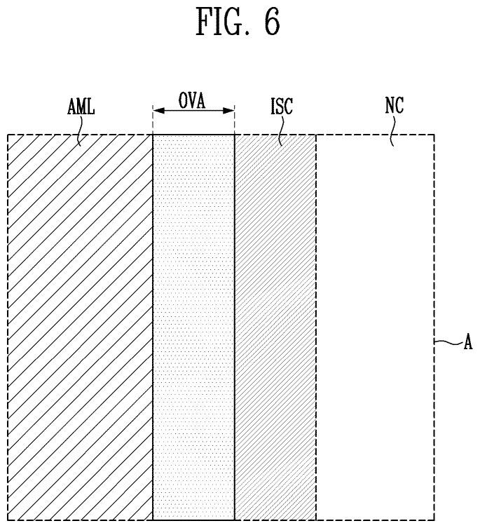

Referring further to FIG. 3, the electrode sheet ETS may include a current collector, an electrode active material layer AML coated on at least one surface of the current collector, and an insulating coating portion ISC formed at a boundary between the electrode active material layer AML and a non-coated portion NC, which is a portion of the current collector where the electrode active material layer AML is not coated. In this case, a portion where the insulating coating portion ISC and the electrode active material layer AML are overlapped may be defined as an insulating coating overlap portion OVA (see FIG. 6).

The image acquisition unit 12 may be positioned above the stage of the transfer unit 11. The image acquisition unit 12 may irradiate light to the electrode sheet ETS through illumination and record a video of the insulating coating portion ISC. In this case, the image acquisition unit 12 may continuously record a video of the electrode sheet ETS being moved by the transfer unit 11.

The image acquisition unit 12 may include a first illumination LI1 for irradiating light of a predetermined wavelength band, a second illumination LI2 for irradiating white light, and a camera CA. Each of the first illumination LI1 and the second illumination LI2 may be line-type illumination.

In embodiments, the battery inspection apparatus 10 may irradiate the first illumination LI1 onto the electrode sheet ETS to record a video of the insulating coating overlap portion OVA. Through the video recorded under the first illumination LI1, the controller 13 may derive the width of the insulating coating overlap portion OVA. In addition, through the video recorded under the first illumination LI1, the controller 13 may detect defects such as gaps, line breaks, or bead breaks of the insulating coating portion ISC.

In embodiments, a wavelength range of the first illumination LI1 may be greater than about 350 nm and less than about 495 nm. When the wavelength range of the first illumination LI1 is equal to or less than about 350 nm or equal to or greater than about 495 nm, the insulating coating overlap portion OVA may not be visible. That is, the insulating coating overlap portion OVA may be visible only when the wavelength range of the first illumination LI1 is greater than about 350 nm and less than about 495 nm.

In embodiments, the first illumination LI1 may form an angle range of greater than about 75 degrees and less than about 95 degrees with respect to the insulating coating portion ISC. When the first illumination LI1 forms an angle range of equal to or less than about 75 degrees or equal to or greater than about 95 degrees with respect to the insulating coating portion ISC, the insulating coating overlap portion OVA may not be visible. That is, the insulating coating overlap portion OVA may be visible only when the first illumination LI1 forms an angle range of greater than about 75 degrees and less than about 95 degrees with respect to the insulating coating portion ISC.

The first illumination LI1 may be arranged in a fixed state at a predetermined position within the angle range of greater than about 75 degrees and less than about 95 degrees with respect to the insulating coating portion ISC. In this case, the predetermined position may refer to a state in which the insulating coating overlap portion OVA is located at an angle where it is most clearly visible.

In embodiments, a distance between the first illumination LI1 and the insulating coating portion ISC may be between about 90 mm and about 110 mm. When the distance between the first illumination LI1 and the insulating coating portion ISC is less than about 90 mm, a video recorded through the image acquisition unit 12 may be excessively exposed, causing the brightness level to rise excessively, and the insulating coating overlap portion OVA may not be visible. In addition, when the distance between the first illumination LI1 and the insulating coating portion ISC is greater than about 110 mm, a video recorded through the image acquisition unit 12 may be underexposed, causing the brightness level to decrease, and the insulating coating overlap portion OVA may not be visible.

In embodiments, the battery inspection apparatus 10 may irradiate the second illumination LI2 onto the electrode sheet ETS to record a video of the electrode sheet ETS. Through the video recorded under the second illumination LI2, the controller 13 may detect a surface defect of the insulating coating portion ISC. Specifically, by changing an irradiation angle of the second illumination LI2, defects such as pinholes and bubbles may be detected through shadows on the surface. In this case, the controller 13 may inspect surface defects not only of the insulating coating portion ISC but also of the entire electrode sheet ETS including the insulating coating portion ISC, the non-coated portion NC, and the electrode active material layer AML, through the video recorded under the second illumination LI2.

Through the video recorded under the second illumination LI2, the controller 13 may detect defects such as gaps, line breaks, or bead breaks of the insulating coating portion ISC.

In embodiments, a wavelength range of the second illumination LI2 may be greater than about 380 nm and less than about 760 nm. The second illumination LI2 may be light in which a plurality of wavelength ranges of light greater than about 380 nm and less than about 760 nm are mixed. When the wavelength range of the second illumination LI2 is equal to or less than about 380 nm or equal to or greater than about 760 nm, visibility of defects such as pinholes, bubbles, or contamination of the non-coated portion NC in an image recorded under the second illumination LI2 may deteriorate. That is, when the wavelength range of the second illumination LI2 is equal to or less than about 380 nm or equal to or greater than about 760 nm, defect detection may become difficult.

In embodiments, the second illumination LI2 may form an angle range of greater than about 85 degrees and less than about 105 degrees with respect to the insulating coating portion ISC. When the second illumination LI2 forms an angle range of equal to or less than about 85 degrees or equal to or greater than about 105 degrees with respect to the insulating coating portion ISC, visibility of defects such as pinholes, bubbles, or contamination of the non-coated portion NC in an image recorded under the second illumination LI2 may deteriorate. That is, when the second illumination LI2 forms an angle range of equal to or less than about 85 degrees or equal to or greater than about 105 degrees with respect to the insulating coating portion ISC, defect detection may become difficult.

In embodiments, a distance between the second illumination LI2 and the insulating coating portion ISC may be between about 90 mm and about 110 mm. When the distance between the second illumination LI2 and the insulating coating portion ISC is less than about 90 mm, a video recorded through the image acquisition unit 12 may be excessively exposed, causing the brightness level to rise excessively, and the insulating coating overlap portion OVA may not be visible. In addition, when the distance between the second illumination LI2 and the insulating coating portion ISC is greater than about 110 mm, a video recorded through the image acquisition unit 12 may be underexposed, causing the brightness level to decrease, and the insulating coating overlap portion OVA may not be visible.

In embodiments, the camera CA may record a video of the insulating coating portion ISC at an angle range of greater than about 45 degrees and less than about 65 degrees with respect to the insulating coating portion ISC. When the angle range of the camera CA is equal to or less than about 45 degrees or equal to or greater than about 65 degrees, visibility of the insulating coating overlap portion OVA and defects such as pinholes, bubbles, or contamination of the non-coated portion NC may deteriorate.

The camera CA may be arranged in a fixed state at a predetermined position within the angle range of greater than about 45 degrees and less than about 65 degrees with respect to the insulating coating portion ISC. In this case, the predetermined position may refer to a state in which the insulating coating overlap portion OVA is located at an angle where it is most clearly visible.

In embodiments, a resolution of the camera CA may be about 25 micrometers or less. When the resolution of the camera CA is greater than about 25 micrometers, the resolution of the camera CA decreases, and thus visibility of the insulating coating overlap portion OVA and defects such as pinholes, bubbles, or contamination of the non-coated portion NC in an image recorded by the camera CA may deteriorate.

In embodiments, the camera CA may be one line-scan camera. Even when the image acquisition unit 12 includes only one camera CA, the single camera CA may acquire a video recorded under the first illumination LI1 and a video recorded under the second illumination LI2, respectively, in a multi-line shot method.

The controller 13 may control the transfer unit 11. The controller 13 may control the transfer unit 11 to support and move the electrode sheet ETS. The controller 13 may control the image acquisition unit 12. The controller 13 may control the image acquisition unit 12 to record a video of the electrode sheet ETS and acquire an image from the image acquisition unit 12. The controller 13 may determine whether the insulating coating portion ISC is defective through the image obtained from the image acquisition unit 12.

The controller 13 may acquire an image obtained from the image acquisition unit 12, derive a width of the insulating coating overlap portion OVA, and detect a surface defect. In this case, the image obtained from the image acquisition unit 12 may include a video recorded under the first illumination LI1 and a video recorded under the second illumination LI2.

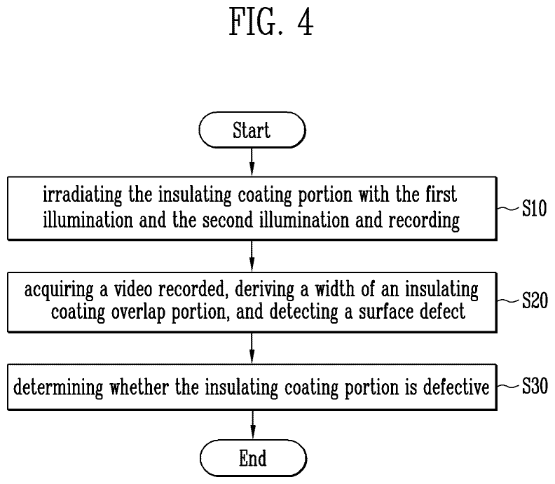

FIG. 4 is a flowchart illustrating an example of a battery inspection method according to the present disclosure.

Referring to FIGS. 1 to 4, the battery inspection apparatus 10 may perform a step S10 of irradiating a first illumination LI1 that irradiates light of a predetermined wavelength band and a second illumination LI2 that irradiates white light while transferring, by the transfer unit 11, an electrode sheet ETS including an insulating coating portion ISC formed at a boundary between an electrode active material layer AML and a non-coated portion NC, and recording a video through the image acquisition unit 12 under control of the controller 13.

The battery inspection apparatus 10 may perform a step S20 of acquiring a video recorded through the image acquisition unit 12, and deriving a width of an insulating coating overlap portion OVA in which the insulating coating portion ISC and the electrode active material layer AML are overlapped and detecting a surface defect through the controller 13.

Specifically, the controller 13 may derive a width of the insulating coating overlap portion OVA based on a video recorded by irradiating the first illumination LI1. In addition, the controller 13 may detect a surface defect of the insulating coating overlap portion OVA based on a video recorded by irradiating the second illumination LI2.

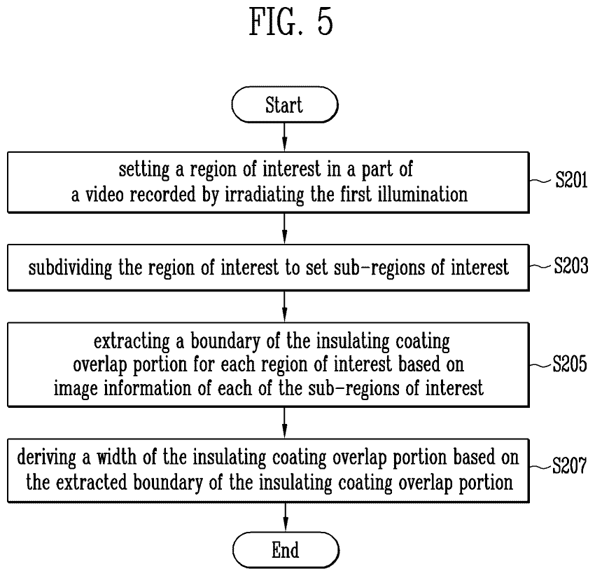

FIG. 5 is a flowchart specifically illustrating step S20 of FIG. 4. FIG. 6 is a plan view showing an enlarged view of region A of FIG. 3.

Referring further to FIGS. 5 and 6, the controller 13 may control the image acquisition unit 12 to irradiate the first illumination LI1 onto the electrode sheet ETS. The controller 13 may set a region of interest R in a part of a video recorded under the first illumination LI1 S201. In this case, the region of interest R may be set such that both boundaries of the insulating coating overlap portion OVA are included within the region of interest R so that the boundaries of the insulating coating overlap portion OVA can be measured.

Specifically, one side of the region of interest R may overlap with a boundary between the electrode active material layer AML and the insulating coating overlap portion OVA, and the other side of the region of interest R opposite to the one side may overlap with a boundary between the insulating coating portion ISC and the non-coated portion NC. That is, by setting the region of interest R in this manner, both boundaries of the insulating coating overlap portion OVA within the region of interest R can be extracted.

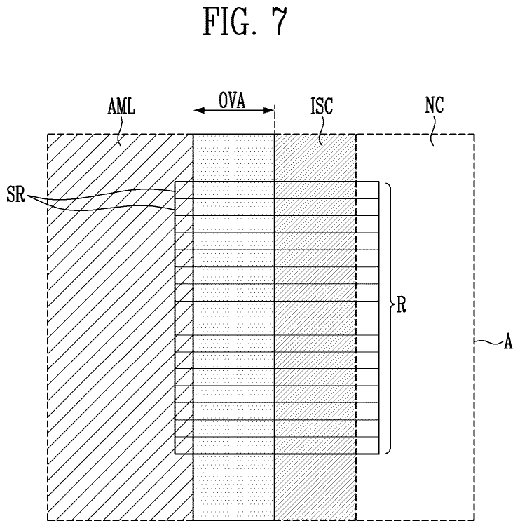

FIG. 7 is a plan view showing sub-regions of interest set in region A of FIG. 6.

Referring further to FIG. 7, the controller 13 may set sub-regions of interest SR obtained by subdividing the region of interest R S203. The sub-regions of interest SR may be located within the region of interest R and may be set to overlap with the boundary of the insulating coating overlap portion OVA.

The controller 13 may extract image information of each of the sub-regions of interest SR. The controller 13 may extract a boundary of the insulating coating overlap portion OVA for each sub-region of interest SR based on the image information of each of the sub-regions of interest SR S205. Specifically, each of the sub-regions of interest SR may be composed of a plurality of pixels, and the image information of each of the sub-regions of interest SR may include a plurality of pixel values (for example, brightness). That is, the controller 13 may generate a profile, which is graph data showing how the pixel values (for example, brightness) in the sub-region of interest SR change, for each of the sub-regions of interest SR. The controller 13 may find a point at which a rapid change occurs in the generated profile and extract the point as the boundary of the insulating coating overlap portion OVA for each of the sub-regions of interest SR.

The controller 13 may derive a width of the insulating coating overlap portion OVA based on the extracted boundary of the insulating coating overlap portion S207. Since both boundaries of the insulating coating overlap portion OVA have been extracted, the controller 13 may derive the width of the insulating coating overlap portion OVA.

The battery inspection apparatus 10 may finally perform a step S30 of determining whether the insulating coating portion ISC is defective based on the width of the insulating coating overlap portion OVA and whether a surface defect is present, through the controller 13.

In embodiments, by applying a composite wavelength inspection method of acquiring images irradiated by the first illumination LI1 and the second illumination LI2, which irradiate different light, with a single camera CA, it is possible to simultaneously detect not only a surface defect of the insulating coating portion ISC but also a width defect of the insulating coating overlap portion OVA using the image acquisition unit 12 including the single camera CA. Accordingly, it is possible to determine whether the insulating coating portion ISC is defective and prevent outflow of a defective insulating coating portion ISC. In addition, material loss caused by sample inspection can be reduced, thereby improving manufacturing efficiency of the electrode sheet ETS.

The present disclosure may be embodied in various forms, and the scope of rights is not limited to the above-described embodiments. Therefore, if a modified embodiment includes the elements of the claims of the present disclosure, it should be construed as falling within the scope of the present disclosure.

What is claimed is:

1. A battery inspection apparatus, comprising:
a transfer unit configured to support and move an electrode sheet including an insulating coating portion formed at a boundary between an electrode active material layer and a non-coated portion;
an image acquisition unit configured to record a video of the insulating coating portion and including a first illumination for irradiating light of a predetermined wavelength band to the electrode sheet and a second illumination for irradiating white light; and
a controller configured to acquire an image obtained from the image acquisition unit, derive a width of an insulating coating overlap portion in which the insulating coating portion and the electrode active material layer are overlapped, and detect a surface defect.

2. The battery inspection apparatus according to claim 1, wherein the image acquisition unit further comprises one camera configured to record a video of the insulating coating portion at an angle range of greater than 45 degrees and less than 65 degrees with respect to the insulating coating portion.

3. The battery inspection apparatus according to claim 2, wherein a resolution of the camera is 25 micrometers or less.

4. The battery inspection apparatus according to claim 1, wherein the first illumination forms an angle range of greater than 75 degrees and less than 95 degrees with respect to the insulating coating portion.

5. The battery inspection apparatus according to claim 1, wherein a wavelength range of the predetermined wavelength band of the first illumination is greater than 350 nm and less than 495 nm.

6. The battery inspection apparatus according to claim 1, wherein a distance between the first illumination and the insulating coating portion is between 90 mm and 110 mm.

7. The battery inspection apparatus according to claim 1, wherein the second illumination forms an angle range of greater than 85 degrees and less than 105 degrees with respect to the insulating coating portion.

8. The battery inspection apparatus according to claim 1, wherein a wavelength range of the second illumination is greater than 380 nm and less than 760 nm.

9. The battery inspection apparatus according to claim 1, wherein a distance between the second illumination and the insulating coating portion is between 90 mm and 110 mm.

10. The battery inspection apparatus according to claim 1, wherein the image obtained from the image acquisition unit includes a video recorded under the first illumination and a video recorded under the second illumination.

11. The battery inspection apparatus according to claim 10, wherein the controller is configured to set a region of interest in a part of the video recorded under the first illumination.

12. The battery inspection apparatus according to claim 11, wherein the controller is configured to set sub-regions of interest obtained by subdividing the region of interest.

13. The battery inspection apparatus according to claim 12, wherein the controller is configured to extract a boundary of the insulating coating overlap portion for each sub-region of interest based on image information of each of the sub-regions of interest.

14. The battery inspection apparatus according to claim 13, wherein the controller is configured to derive a width of the insulating coating overlap portion based on the extracted boundary of the insulating coating overlap portion.

15. The battery inspection apparatus according to claim 10, wherein the controller is configured to detect a surface defect of the insulating coating portion based on the video recorded under the second illumination.

16. The battery inspection apparatus according to claim 1, wherein the controller is configured to determine whether the insulating coating portion is defective based on the width of the insulating coating overlap portion and whether a surface defect is present.

17. A battery inspection method, comprising:
irradiating a first illumination that irradiates light of a predetermined wavelength band and a second illumination that irradiates white light while transferring, by a transfer unit, an electrode sheet including an insulating coating portion formed at a boundary between an electrode active material layer and a non-coated portion, and recording a video through an image acquisition unit; and
acquiring a video recorded through the image acquisition unit, and deriving a width of an insulating coating overlap portion in which the insulating coating portion and the electrode active material layer are overlapped and detecting a surface defect through a controller.

18. The battery inspection method according to claim 17, wherein the deriving of the width of the insulating coating overlap portion and detecting of the surface defect comprises:
deriving the width of the insulating coating overlap portion based on a video recorded by irradiating the first illumination; and
detecting a surface defect of the insulating coating overlap portion based on a video recorded by irradiating the second illumination.

19. The battery inspection method according to claim 18, wherein the deriving of the width of the insulating coating overlap portion comprises:
setting a region of interest in a part of a video recorded by irradiating the first illumination;
subdividing the region of interest to set sub-regions of interest;
extracting a boundary of the insulating coating overlap portion for each of the sub-regions of interest based on image information of each of the sub-regions of interest; and
deriving the width of the insulating coating overlap portion based on the extracted boundary of the insulating coating overlap portion.

20. The battery inspection method according to claim 17, further comprising determining whether the insulating coating portion is defective based on the width of the insulating coating overlap portion and whether a surface defect is present.
